(19) United States
(12) Patent Application Publication
(10) Pub. No.: US 2005/0194874 A1
(43) Pub. Date: Sep. 8, 2005

(54) Refrigerator

(75) Inventor: Suk-ho Jang, Kwangiu-si (KR)

Correspondence Address: STAAS & HALSEY LLP, SUITE 700, 1201 NEW YORK AVENUE, N.W., WASHINGTON, DC, 20005, US

(73) Assignee: Samsung Electronics, Co., Ltd., Suwon-si (KR)

(21) Appl. No.: 10/972,378

(22) Filed: Oct. 26, 2004

(30) Foreign Application Priority Data
Mar. 5, 2004 (KR) 2004-15032

(51) Int. Cl. B60J 5/00; A47B 96/04

(52) U.S. Cl. 312/405

(57) ABSTRACT

A refrigerator including a main body cabinet having an opening at a side; a door provided on the main body cabinet to open/close the opening; a hinge provided between the door and the main body cabinet to rotatably support the door with respect to the main body cabinet; and a door reinforcement disposed inside the door to be connected to the hinge and to prevent a twist of the door, the door reinforcement having a plate shape and formed with a hinge accommodating part to accommodate the hinge therein.

### CROSS-REFERENCE TO RELATED APPLICATION

This application claims the benefit of Korean Patent Application No. 2004-15032, filed Mar. 5, 2004 in the Korean Intellectual Property Office, the disclosure of which is incorporated herein by reference.

### BACKGROUND OF THE INVENTION

1. Field of the Invention

The present invention relates to a refrigerator, and, more particularly, to a refrigerator having an improved door reinforcement to prevent a twist of a door.

2. Description of the Related Art

As shown in FIG. 5, a conventional refrigerator comprises a main body cabinet (not shown) having a storage compartment with an opening, a door 220 provided on the main body cabinet to open/close the opening and a hinge 230 that is provided between the door 220 and the main body cabinet to rotatably support the door 20 with respect to the main body cabinet. The door 220 comprises an exterior portion 220a to form an external appearance and an interior portion (not shown) that is separated from the exterior portion 220a. The space formed between the interior portion and the exterior portion 220a is filled with foam material.

The door 220 further comprises a door reinforcement 240 to prevent a torsion that is caused due to the weight of the door 20 or to a concentration of stresses that occur when the door rotates with respect to the hinge 230. The door reinforcement 240 is provided between an exterior portion 220a and an interior portion to be connected to the hinge 230. The door reinforcement 240 has a substantially “L” shape. The door reinforcement 240 has a hinge accommodating part 241 to accommodate the hinge 230 and a plurality of screw holes 243 through which a screw 244 may be inserted. The door reinforcement 240 is connected with a hinge supporter 242 that is provided in the vicinity of the hinge accommodating part 241 to accommodate and support the hinge 230.

With this configuration, the door reinforcement 240 may prevent an undesirable twisting of the door due to the concentration of the stress around the hinge or the weight of the door.

However, in the conventional refrigerator, the door reinforcement 240 has a substantially “L” shape, which may cause a burr during a forming process. Thus, the shape of the door reinforcement 240 may cause a deterioration of the quality of the door 220 n and, further, may cause difficulty with mounting the door reinforcement 240 on the door 220. Further, a hinge supporter is provided separately from the door reinforcement 240, so that an additional process to connect the hinge supporter to the door reinforcement 240 is required and manufacturing costs rise.

### SUMMARY OF THE INVENTION

Accordingly, the present invention provides a refrigerator having a door reinforcement of a simple shape to be easily mounted on a door.

The foregoing and/or other aspects of the present invention are also achieved by providing a refrigerator comprising: a main body cabinet having an opening at a side; a door provided on the main body cabinet to open/close the opening; a hinge provided between the door and the main body cabinet to rotatably support the door with respect to the main body cabinet; and a door reinforcement disposed inside the door to be connected to the hinge and to prevent a twist of the door, the door reinforcement having a plate shape and being formed with a hinge accommodating part to accommodate the hinge.

According to another aspect of the present invention, the refrigerator further comprises a hinge supporter provided around the hinge accommodating part to accommodate and support the hinge.

According to another aspect of the present invention, the hinge supporter and the door reinforcement are integrally formed.

According to another aspect of the present invention, the door reinforcement comprises a bent part that is formed by cutting out and bending at least one part of the door reinforcement and having a through hole to pass therethrough a cable connected to the inside of the door.

According to another aspect of the present invention, the door reinforcement has a screw hole to connect the door reinforcement to the door on a surface thereof.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a front perspective view of a refrigerator according to the present invention;

FIG. 2 is a perspective view illustrating the rear of a door of a refrigerator including a door reinforce and a hinge according to a first embodiment of the present invention;

FIG. 3 is an enlarged view illustrating the door reinforce of the refrigerator according to the first embodiment of the present invention;

FIG. 4 is an enlarged view illustrating a door reinforce of a refrigerator according to a second embodiment of the present invention; and

FIG. 5 is a partial perspective view of a door of a conventional refrigerator.

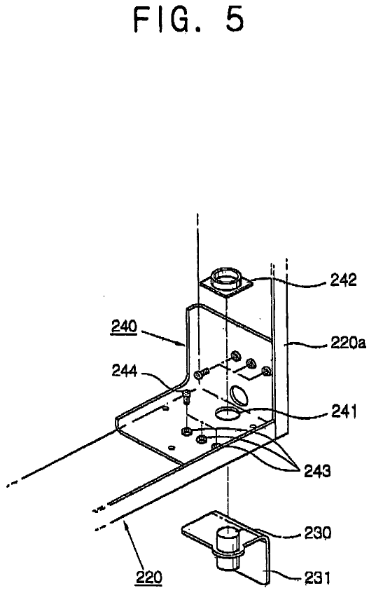

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

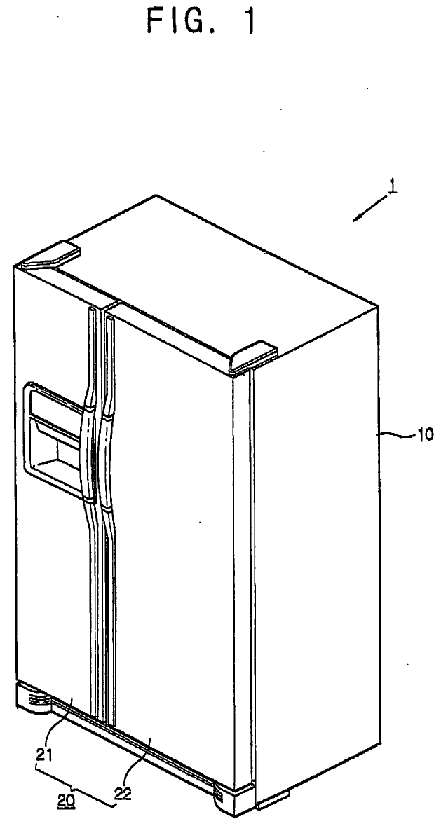

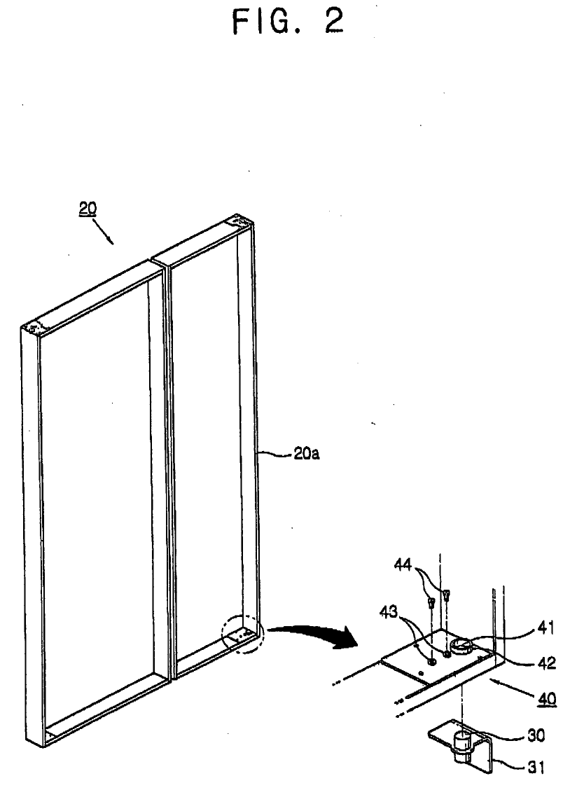

Referring to FIGS. 1 and 2, a refrigerator 1 according to an embodiment of the present invention comprises a main body cabinet 10, having a storage compartment with an opening, a door 20, provided on the main body cabinet 10, to open/close the opening, and a hinge that is provided between the door 20 and the main body cabinet 10 to rotatably support the door 20 with respect to the main body cabinet 10. The hinge comprises an upper hinge (not shown) and a lower hinge 30.

The lower hinge 30 includes a cylindrical solid shaft having a predetermined length and diameter. The outside surface of the shaft has, in an embodiment of the invention, a sufficient smoothness so as to allow the shaft to rotate freely within a through hole that has an inside surface having a substantially similar diameter as the diameter of the shaft. The through hole will be discussed below.

An upper main body hinge bracket (not shown) and a lower main body hinge bracket (not shown) are connected to the upper hinge and the lower hinge 30, respectively. The upper main body hinge bracket and the lower main body hinge bracket are provided at an upper part and a lower part of the main body cabinet 10, respectively.

The door 20 may refer to either a freezing compartment door 21 or a cooling compartment door 22 to open/close an opening of a freezing compartment and a cooling compartment, respectively, although for purposes of the present application the door 20 refers to a single door that is generic to both types of doors. The door 20 comprises an exterior portion 20a to form an external appearance and an interior portion (not shown) that is separated from the exterior portion. The space between the interior portion and the exterior portion 20a is filled with a material (e.g., foam).

The door 20 further comprises an upper door hinge bracket (not shown) and a lower door hinge bracket 31 each of which are connected to the upper hinge and the lower hinge 30 on an upper part and a lower part of the door 20, respectively. An upper hinge through hole (not shown) and a lower hinge through hole (not shown) are formed in the upper door hinge bracket and the lower door hinge bracket to allow the upper hinge and the lower hinge 30 to pass through the upper door hinge bracket and the lower door hinge bracket, respectively. The upper hinge through hole and the lower hinge through hole are formed on an upper surface and a lower surface of the door 20, respectively.

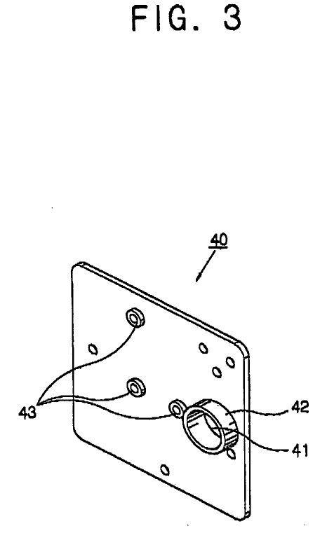

As shown in FIGS. 2 and 3, the door 20 further comprises a door reinforcement 40 to prevent twisting that is caused due to the weight of the door 20 or to a concentration of stresses when the door 20 rotates with respect to the lower hinge 30.

The door reinforcement 40 is connected to the lower hinge 30 inside the door 20 and is shaped substantially like a plate having a predetermined width that is sufficient to reinforce the door 20. The door reinforcement 40 includes a hinge accommodating part 41 formed on a surface thereof. The hinge accommodating part 41 serves to physically accommodate the hinge 30 because the hinge accommodating part 41 includes a cylindrical shaft that is opened at both ends to define a through hole extending through the hinge accommodating part 41. The interior cylindrical surface of the shaft has a diameter that is substantially similar to that of the lower hinge 30. As a result, when the shaft of lower hinge 30 is inserted into the through hole of the hinge accommodating part 41, the lower hinge 30 is accommodated therein. Because the door reinforcement 40 has a simple shape and is easily manufactured, the quality of the door reinforcement 40 is improved and a manufacturer may mount the door reinforcement 40 on the door 20 with relative ease in comparison to the effort required to install the conventional door reinforcement 240.

The door reinforcement 40 further has a plurality of screen holes 43 so as to allow the door reinforcement 40 to be connected to the door 20. Screws 44 are respectively inserted in each of the screen holes 43 to connect the door reinforcement 40 to the door 20.

In a further embodiment of the present invention, the refrigerator 1 may further comprise a hinge supporter 42 around the hinge accommodating part 41 of the door reinforce 40. The hinge supporter 42 serves to accommodate and support the hinge 30 that passes through the through hole of the hinge accommodating part 41 so as to protrude from the surface of the door reinforcement 40. The door reinforcement 40 and the hinge supporter 42 are integrally formed, which reduces the number of manufacturing processes and decreases manufacturing cost.

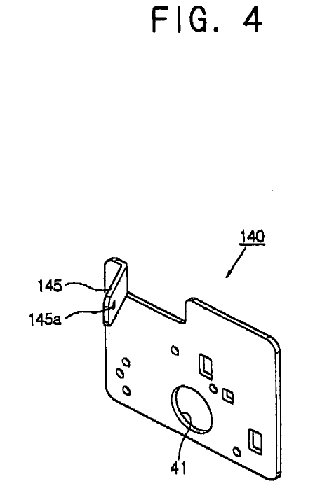

While the door reinforcement 40 and the hinge supporter 42 are integrally formed in the embodiment described above, according to another embodiment of the present invention, the present invention can be implemented without the hinge supporter as shown in FIG. 4. The door reinforcement 140 further comprises a bent part 145 that is formed by cutting out and bend a part of the door reinforcement 140 and the bent part 145 has a through hole 145a on a surface thereof. A cable is inserted in the through hole 145a of the bent part 145, which prevents the cable (not shown) connected to the inside of the door from a sway.

It is understood that, while the door reinforcement is mounted at a position on which the lower hinge is disposed, the door reinforcement may be mounted at any and all positions on which the hinge is connected.

It is further understood that, while the refrigerator is implemented as a side-by-side type in the embodiment described above, the present invention may be applied to a refrigerator partitioned in an up-and-down direction and/or a Kimchi refrigerator.

As is described above, the present invention provides the refrigerator having the door reinforce of a simple shape and easy to be mounted on the inside of the door.

Although a few embodiments of the present invention have been shown and described, it would be appreciated by those skilled in the art that changes may be made in these embodiments without departing from the principles and spirit of the invention, the scope of which is defined in the claims and their equivalents.

1. A refrigerator comprising:
a main body cabinet having an opening at a side;
a door, provided on the main body cabinet, to open/close the opening;
a hinge, provided between the door and the main body cabinet, to rotatably support the door with respect to the main body cabinet; and
a door reinforcement disposed inside the door to be connected to the hinge and to prevent a twist of the door, the door reinforcement having a plate shape and being formed with a hinge accommodating part to accommodate the hinge therein.

2. The refrigerator according to claim 1, further comprising a hinge supporter provided around the hinge accommodating part to accommodate and support the hinge.

3. The refrigerator according to claim 2, wherein the hinge supporter and the door reinforce are integrally formed.

4. The refrigerator according to claim 1, wherein the door reinforcement comprises a bent part formed by cutting out and bending at least one part of the door reinforcement, the bent part having a through hole to pass a cable, which is connected to the inside of the door, therethrough.

5. The refrigerator according to claim 1, wherein the door reinforcement includes a screw hole to connect the door reinforcement to the door on a surface thereof.

6. The refrigerator according to claim 2, wherein the door reinforcement includes a screw hole to connect the door reinforcement to the door on a surface thereof.

7. The refrigerator according to claim 3, wherein the door reinforcement includes a screw hole to connect the door reinforcement to the door on a surface thereof.

8. The refrigerator according to claim 4, wherein the door reinforcement includes a screw hole to connect the door reinforcement to the door on a surface thereof.

9. A refrigerator including a main body cabinet, having an opening at a side, and a door, provided on the main body cabinet, to open/close the opening, the refrigerator comprising:
a hinge to rotatably support the door with respect to the main body cabinet;
a substantially plate-shaped door reinforcement disposed inside the door to be connected with the hinge and to prevent an undesirable twist of the door; and
a hinge accommodating part, to accommodate the hinge therein, the hinge accommodating part being formed on the door reinforcement.

10. The refrigerator according to claim 9, wherein the substantially plate-shaped door reinforcement has sufficient dimensions so as to prevent undesirable strains on the door.

11. The refrigerator according to claim 9, wherein a space in the hinge accommodating part defines a through hole through which the hinge extends and in which the hinge is securely held.

12. The refrigerator according to claim 11, wherein the hinge accommodating part comprises a hinge supporter, the hinge supporter having a hollow cylindrical shape through which a portion of the hinge that projects from the through hole in the hinge accommodating part extends and in which the portion is securely held.

13. The refrigerator according to claim 9, wherein the substantially plate-shaped door reinforcement comprises screw holes to allow the substantially plate-shaped door reinforcement to be connected to the door.

14. The refrigerator according to claim 9, wherein the substantially plate-shaped door reinforcement comprises a bent part having a through hole on a surface thereof.

15. A refrigerator including a main body cabinet, having an opening at a side, and a door, provided on the main body cabinet, to open/close the opening, the refrigerator comprising:
a hinge to rotatably support the door with respect to the main body cabinet;
a substantially plate-shaped door reinforcement disposed inside the door to define a through hole therein through which the hinge extends, wherein the substantially plate-shaped door reinforcement has sufficient dimensions so as to prevent undesirable strains on the door.

16. The refrigerator according to claim 15, further comprising a hinge accommodating part integrally formed with the substantially plate-shaped door reinforcement, wherein a space in the hinge accommodating part defines a through hole through which the hinge extends and in which the hinge is securely held.

17. The refrigerator according to claim 16, wherein the hinge accommodating part comprises a hinge supporter, the hinge supporter having a hollow cylindrical shape through which a portion of the hinge that projects from the through hole in the hinge accommodating part extends and in which the portion is securely held.

18. The refrigerator according to claim 15, wherein the substantially plate-shaped door reinforcement comprises screw holes to allow the substantially plate-shaped door reinforcement to be connected to the door.

19. The refrigerator according to claim 15, wherein the substantially plate-shaped door reinforcement comprises a bent part having a through hole on a surface thereof.
